(19) United States
(12) Patent Application Publication
(10) Pub. No.: US 2010/0213343 A1
(43) Pub. Date: Aug. 26, 2010

(54) Book Rest With Page Holder

(76) Inventor: Cindy Jane Opresnik, Melbourne (AU)

Correspondence Address: MINTZ LEVIN COHN FERRIS GLOVSKY & POPEO, ONE FINANCIAL CENTER, BOSTON, MA, 02111, US

(21) Appl. No.: 12/799,738

(22) Filed: Apr. 29, 2010

Related U.S. Application Data
(63) Continuation of application No. 12/221,986, filed on Aug. 8, 2008, now abandoned.
Application No. 12/221,986 is a continuation of application No. 10/566,137, filed on Feb. 5, 2007, now abandoned.

(51) Int. Cl. B42D 9/00

(52) U.S. Cl. 248/451

(57) ABSTRACT

The disclosed book rest is a bean filled bag (G), having insert (1), for which a book will rest on, with its front and back leaning against inserts (H), with page holder (B), held in position by toggle (A), threaded onto elastic (C), which is attached at point (D), enabling page holder (B) to slide up the elastic (C), pressing firmly against the book enabling sections (E), to slide under the edges of the book, thus ensuring sections (B1) and (B2), press firmly against the book pages, therefore keeping the book open.

The invention may be better understood with reference to the illustrations of embodiments of the invention I which:

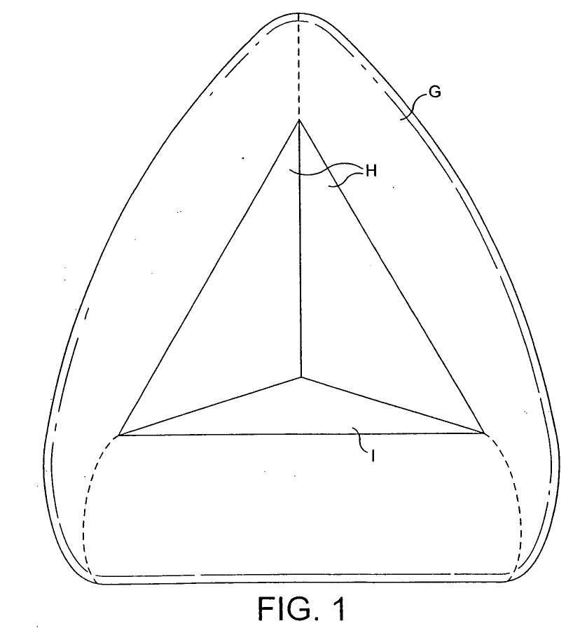

FIG. 1. is a elevation of the book rest showing the concave shaped inserts of flat sections on which the book sits.

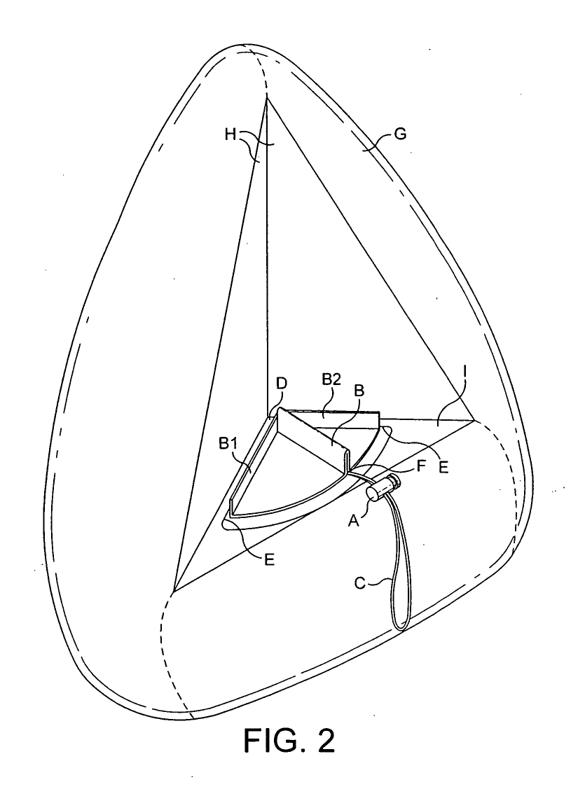

FIG. 2. is a perspective view of the book rest with the page holder in place.

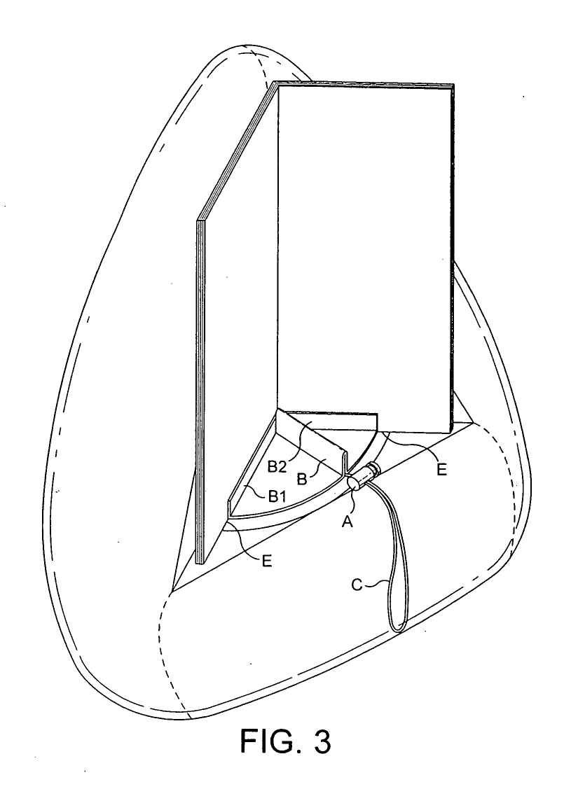

FIG. 3. is a perspective view of the page holder, holding a book in an open position.

The book rest which is shown in FIG. 1. is made of flexible and pliable material (G), containing a suitable particle matter such as foam beads, balls or beans, which enable the flexibility needed to adjust its position and sit comfortably on any surface. The reader's book then sits on the stiff insert (1), in an open position, leaning on stiff inserts (H).

FIG. 2. Shows the page holder (B), which is made of a stiff perspex or plastic like material.

Elastic (C) is threaded through hole (F), in said page holder, and attached to the “Book Buddy” book rest at point (D).

Toggle (A), can move along the elastic (C), for easy adjustment.

Page holder edges (E), slide under each side of the book to keep it in place.

FIG. 3. Shows a book in an open position, resting on the book rest. To ensure that the pages don't move, and that the reader can indeed read hands free, the page holder edges (E), slide under the edges of the book to allow parts (B1) and (B2), to press firmly against the pages of the book.

Toggle (A), slides up and tensions the elastic (C), to pull and hold the page holder in position.

Page holder (B), can be slid towards the reader and away from the book, whilst sill under some tension from the elastic.

1.-12. (canceled)

13. A book rest comprises a beam filled bag, with concave shaped inserts of flat sections, one on which the book sits, with the back of the book resting on the other two corresponding sections.

14. A book rest as claimed in claim 1, where in the book rest has an adjustable page holder that holds the pages open so as to enable the user hands free reading.

15. A book rest as claimed in claim 1, where the beam filled bag is made of a P.V.C. plastic.

16. A book rest as claimed in claim 1, where the bean filled bag is made of a woven fabric.

17. A book rest as claimed in claim 1, where the bean filled bag is made of vinyl.

18. A book rest as claimed in claim 1, where the bean filled bag is made of a cloth material.

19. A book rest as claimed in claim 1, where the bean filled bag is accompanied by a page holder, which is made of perspex.

20. A book rest as claimed in claim 1, where the bean filled bag is accompanied by a page holder, which is made of plastic.

21. A book rest as claimed in claim 1, where the bean filled bag is accompanied by a page holder, which is made of wood.

22. A book rest a claimed in claim 1, where the bean filled bag is accompanied by a pager holder, which is made of fibre glass.

23. A book rest as claimed in claim 1, where the bean filled bag is accompanied by a page holder, which is made of carbon fibre compound.

23. A book rest and page holder as herein before described with references to FIGS. 1-3 of the accompanying drawings.
